(19) United States
(12) Patent Application Publication
(10) Pub. No.: US 2017/0074197 A1
(43) Pub. Date: Mar. 16, 2017

(54) Method for determining the closing characteristic of the control valve of a piezo servo injector

(71) Applicant: CONTINENTAL AUTOMOTIVE GMBH, Hannover (DE)

(72) Inventor: Janos Radeczky, Wenzenbach (DE)

(73) Assignee: CONTINENTAL AUTOMOTIVE GMBH, Hannover (DE)

(21) Appl. No.: 15/359,136

(22) Filed: Nov. 22, 2016

Related U.S. Application Data
(63) Continuation of application No. PCT/EP2015/055794, filed on Mar. 19, 2015.

(30) Foreign Application Priority Data
May 23, 2014 (DE) 10 2014 209 823.8

(51) Int. Cl. F02D 41/20; F02M 65/00

(52) U.S. Cl. CPC F02D 41/2096; F02M 65/005; F02D 41/20; F02D 2041/2055

(57) ABSTRACT

A method for determining a closing characteristic of a valve of a piezo servo injector, including carrying out test charging of an actuator of the piezo servo injector in order to open the control valve and in order to reduce pressure in a control chamber of the piezo servo injector; incompletely discharging the actuator down to a residual partial stroke of the actuator; ascertaining a gradient profile of the pressure drop in the pressure accumulator during the residual partial stroke; and determining the closing characteristic of the control valve from the gradient profile of the pressure drop. The closing characteristic may be the closing time of the valve. The method further includes modifying or adapting a closing process for the valve based upon the determined closing time.

### CROSS-REFERENCE TO RELATED APPLICATIONS

This application is a continuation application of, and claims priority to, international application PCT/EP2015/055794, filed Mar. 19, 2015, designating the United States and claiming priority from German patent application 10 2014 209 823.8, filed May 23, 2014, the content of both applications is hereby incorporated by reference herein in their entirety.

### FIELD OF INVENTION

The present invention relates to a method for determining the closing characteristic of the control valve of a piezo servo injector of an injection system which has a pressure accumulator (i.e., rail).

### BACKGROUND

Ever more stringent requirements are being made with respect to complying with the permissible injection quantity tolerances of the injection valves of motor vehicles. This relates both to newly manufactured injection valves and to older injection valves which are in operation over relatively long periods of time. Here, separate detection of the various influencing variables which are ultimately responsible for correctly complying with the injection quantities is of great importance for robust correction of the actuation of the injectors.

Piezo servo injectors of injection systems which have a pressure accumulator (rail) are distinguished in that a piezo actuator is coupled to a servo control valve for operating the nozzle needle of the injector.

In this case, methods with which the opening behavior of the control valve can be determined are known. In particular, the opening behavior can also be adapted by means of known control algorithms However, to date, there have been no known strategies for identifying closing of the control valve in current systems.

### SUMMARY

Example embodiments are based on providing a method for determining the closing characteristic of the control valve of a piezo servo injector of an injection system which has a pressure accumulator (rail), with which method actuation of an injector of this kind can be further optimized.

According to the example embodiments, such a method includes the following:

carrying out test charging of the actuator of the piezo servo injector in order to open the control valve and in order to reduce pressure in the control chamber;

incompletely discharging the actuator down to a residual partial stroke of the actuator;

ascertaining the gradient of the pressure drop in the pressure accumulator during the residual partial stroke; and

determining the closing characteristic of the control valve from the gradient profile of the pressure drop.

The method according to the example embodiments is initiated with actuation of the actuator of the piezo servo injector, wherein test charging of the actuator is carried out. In the process, the valve is opened and relieved of load in a safe manner, that is to say the pressure in the control chamber is reduced. In the process, the corresponding actuation pulse is preferably selected to be so short that there is no injection or only as little injection as possible into the combustion chambers. The corresponding actuation parameters of the actuator for the test charging can be ascertained, for example, during an idle stroke measurement which is carried out beforehand.

This is followed by incomplete discharging of the actuator down to a residual partial stroke of the actuator. This can be performed, for example, by means of the activation of a post-stroke pulse. The actuator is not completely discharged in a discharge process in any case. The first discharge sets a partial stroke of the actuator.

As a further step, the gradient of the pressure drop in the pressure chamber (rail) is ascertained during the residual partial stroke. Therefore, according to the example embodiment, the signal which is used to determine the valve stroke is the rail pressure gradient during the post-stroke. When a valve is still open, fuel flows across the valve out of the pressure accumulator resulting in injector leakage. The gradient of the pressure drop correlates to the cross section at the valve seat, that is to say to the valve stroke. The entire closing characteristic of the control valve can be determined owing to this correlation. Therefore, the closing characteristic is ascertained from the gradient profile of the pressure drop.

In particular, the method according to an example embodiment is used to ascertain the closing time of the control valve.

The closing characteristic, in particular the closing time, of the control valve can be ascertained, in particular, with the aid of the state of charge or voltage value of the actuator of the piezo servo injector. In other words, that voltage/charge of the piezo actuator at which the valve closes can be ascertained.

The corresponding method can be carried out in any injector in a wide pressure range of the pressure accumulator (rail) at different temperatures. The pressure range is greater than that during identification of valve opening since the drive is already relieved of load during the closing process.

Therefore, the method according to an example embodiment provides further information about injector parameters, using which information actuation of the injector is further optimized and the drift behavior can be compensated for in an optimum manner, for example by correcting the discharge operation, in particular the discharge current or start of discharge, with respect to the valve closing operation.

In a development of the method according to an example embodiment, a correction value can be obtained from the ascertained closing characteristic and the correction value can be used to adapt the valve closing process. In particular, the drift behavior of the injector can be compensated for by adapting the valve closing process in this way.

Since the control valve is still open during partial discharging of the actuator as is carried out according to an example embodiment, the rail pressure is reduced. The embodiment makes use of this, wherein conclusions are drawn about the closing characteristic and, respectively, the closing time of the valve from the corresponding gradient of the pressure drop.

### BRIEF DESCRIPTION OF THE DRAWINGS

Aspects of the invention will be explained in detail below with reference to an exemplary embodiment in conjunction with the drawings, in which:

FIG. 1 shows two graphs which show the actuation voltage or the actuator stroke and the rail pressure as a function of time;

FIG. 2 shows a graph which shows the rail pressure gradient as a function of the post-stroke actuation voltage; and

FIG. 3 shows a graph which shows the rail pressure gradient as a function of the injector voltage, wherein the discharge process at partial stroke and the charging process at partial stroke are illustrated.

### DETAILED DESCRIPTION

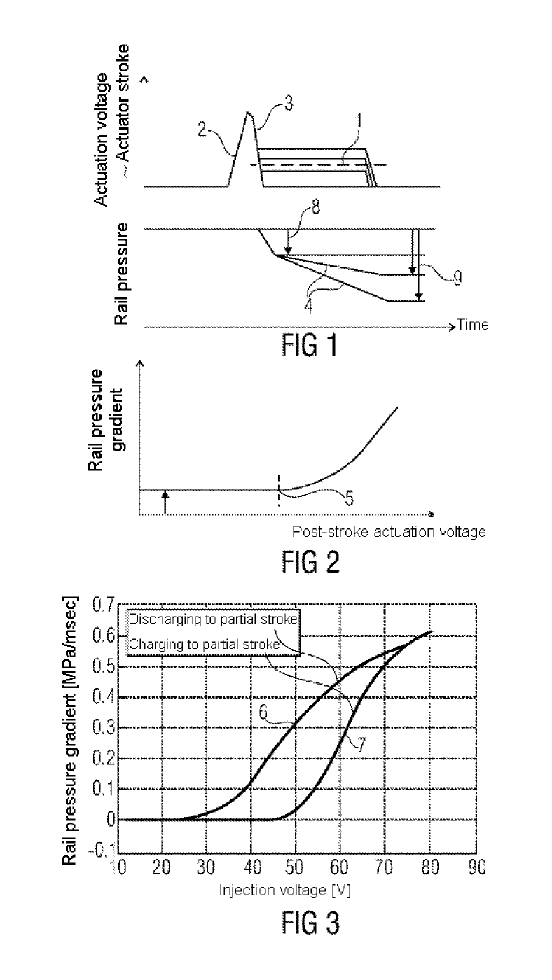

In a method for ascertaining the closing time of the control valve of a piezo servo injector of an injection system which has a pressure accumulator (rail), test charging of the actuator of the piezo servo injector is carried out in order to open the control valve and to reduce the pressure in the control chamber. The corresponding charge pulse is illustrated by 2, and the corresponding discharge pulse is illustrated by 3 in FIG. 1. The closing time of the control valve is indicated by 1. In the lower graph of FIG. 1, the rail pressure is shown as a function of time, wherein the leakage is shown by 9 with the associated initial leakage 8 for the respective actuator stroke. The corresponding rail pressure gradient is shown by 4.

As a second act of the method, incomplete discharging of the actuator down to a residual partial stroke of the actuator takes place, wherein the corresponding actuator strokes and pressure gradients are shown in FIG. 1, as described above. FIG. 2 shows the profile of the rail pressure gradient as a function of the post-stroke actuation voltage, wherein the closing time of the control valve is shown by 5. This closing time corresponds to the start of the increase in the rail pressure gradient.

Therefore, in the method, the gradient of the pressure drop in the pressure accumulator (rail) is ascertained during the corresponding residual partial stroke, and the closing time of the control valve is determined from the gradient.

FIG. 3 shows the relationship between the rail pressure gradient and the injector voltage during discharging to partial stroke (curve 6) and during charging to partial stroke (curve 7).

The description above is merely exemplary in nature and, thus, variations may be made thereto without departing from the spirit and scope of the invention as defined in the appended claims.

What is claimed is:

1. A method for determining the closing characteristic of the control valve of a piezo servo injector of an injection system which has a pressure accumulator, comprising:
carrying out test charging of an actuator of the piezo servo injector in order to open the control valve and in order to reduce pressure in a control chamber of the piezo servo injector;
incompletely discharging the actuator down to a residual partial stroke of the actuator;
ascertaining a gradient profile of the pressure drop in the pressure accumulator during the residual partial stroke; and
determining the closing characteristic of the control valve from the gradient profile of the pressure drop.

2. The method as claimed in claim 1, wherein determining the closing characteristic of the control valve comprises ascertaining a closing time of the control valve.

3. The method as claimed in claim 1, wherein the closing characteristic is determined based upon a state of charge or voltage value of the actuator of the piezo servo injector.

4. The method as claimed in claim 1, wherein test charging the actuator comprises test charging the actuator with an actuation pulse causing zero or near zero fuel being expelled from the piezo servo injector.

5. The method as claimed in claim 1, further comprising performing an idle stroke measurement on the piezo servo injector prior to carrying out the test charging and ascertaining actuation parameters of the actuator from the measurement, wherein the actuation parameters are used in the test charging.

6. The method as claimed in claim 1, further comprising determining a correction value from the closing characteristic, and adapting a closing process for the control valve based upon the correction value.

7. The method as claimed in claim 6, wherein adapting the closing process based upon the correction value compensates for drift behavior of the injector.

8. The method as claimed in claim 6, further comprising applying the adapted closing process to the piezo servo injector for closing the control valve thereof.

9. The method as claimed in claim 6, further comprising actuating the actuator using the adapted closing process to close the valve.

10. A method for determining a closing characteristic of the control valve of a piezo servo injector of an injection system, the injection system including a pressure accumulator and the piezo servo injector including a control chamber and an actuator, the method comprising:
charging the actuator of the piezo servo injector to open the control valve and to reduce pressure in the control chamber;
incompletely discharging the actuator down to a residual partial stroke of the actuator;
ascertaining a gradient profile of a pressure drop in the pressure accumulator during the residual partial stroke; and
determining the closing characteristic of the control valve from the gradient profile of the pressure drop.

11. The method as claimed in claim 10, wherein determining the closing characteristic of the control valve comprises determining a closing time of the control valve.

12. The method as claimed in claim 11, wherein the closing time of the control valve is determined based upon a state of charge or voltage value of the actuator of the piezo servo injector.

13. The method as claimed in claim 11, further comprising determining a correction value from the determined closing time and modifying a closing process for the control valve based upon the correction value.

14. The method as claimed in claim 13, wherein modifying the closing process based upon the correction value compensates for drift behavior of the injector. The method as claimed in claim 13, further comprising applying the modified closing process to the piezo servo injector for closing the control valve thereof.

16. The method as claimed in claim 13, further comprising actuating the actuator using the modified closing process to close the valve.

17. The method as claimed in claim 10, wherein charging the actuator comprises charging the actuator with an actuation pulse causing zero or near zero fuel to be expelled from the piezo servo injector.

18. The method as claimed in claim 10, further comprising performing an idle stroke measurement on the piezo servo injector prior to charging the actuator, and determining actuation parameters of the actuator from the idle stroke measurement, wherein charging the actuator is based on the actuation parameters.
